(19) United States
(12) Patent Application Publication
(10) Pub. No.: US 2024/0083013 A1
(43) Pub. Date: Mar. 14, 2024

(54) Stand for a Tool

(71) Applicant: Michael Terence O'Connell, Shailer Park (AU)

(72) Inventor: Michael Terence O'Connell, Shailer Park (AU)

(21) Appl. No.: 18/133,653

(22) Filed: Apr. 12, 2023

(30) Foreign Application Priority Data
Sep. 12, 2022 (AU) 2022902621

(51) Int. Cl. B25H 1/10; B25H 1/02; F16M 11/20

(52) U.S. Cl. CPC B25H 1/10; B25H 1/02; F16M 11/2021; F16M 2200/063; F16M 2200/068

(57) ABSTRACT

A stand for a power tool or an appliance, wherein the stand includes a base for mounting to an external mounting surface, a transitioning arrangement having one end mounted to the base and an opposed end remote from the base, and a mount for mounting the power tool or appliance thereon that is mounted on the opposed end of the transitioning arrangement, wherein the transitioning arrangement enables the mounting formation to be displaced between a raised inoperative configuration for storage, and a lowered operative configuration for use.

### CROSS REFERENCE TO RELATED APPLICATION

This application claims the benefit of AU Provisional Application No. 2022902621 filed on Sep. 12, 2022. The above identified patent application is herein incorporated by reference in its entirety.

### BACKGROUND OF THE INVENTION

The present invention relates to a stand for a device such as a power tool or an appliance. It relates particularly but not exclusively to a stand for holding a tool that is used on a work bench in a workshop or the like. It will therefore be convenient to hereinafter describe this invention with reference to this example application. However, it is to be clearly understood that the invention is capable of broader application. For example, the stand could also be used for holding a kitchen appliance that is used on a kitchen benchtop. Further the stand may also be used for a myriad of other applications.

The surfaces of existing work benches are used to support a power tool such as an angle grinder, a hole punch, a press, a drill, or a saw. An example work bench used in the known art is illustrated in FIG. 1. The work bench has a work surface, and a vice or clamp is mounted on a front edge of the work surface. The vice is permanently mounted in the fixed position on the work bench that is shown in the drawing. This then encroaches on the available bench space for use with other tools and implements.

To function effectively, power tools need to be secured or fixed to a work bench. This securement then acts to hold the tool in position when it is being used and is subjected to forces relating to its use, e.g. high speed rotation of an angle grinder or a drill. Consequently, it is extremely common for tools of this nature to be permanently mounted in a single position on the work bench. Typically, the tool is secured to the bench by means of permanent fasteners that pass through the tool and the bench, or by clamping the tool to the bench. While only a vice is shown in FIG. 1, it would be quite common for a work bench to have other tools permanently mounted in position on another region of the work bench. For example, such a tool could be mounted in the zone indicated by the letter ‘X’ in FIG. 1.

Further, if two or more tools are permanently mounted alongside each other on a bench, this can significantly reduce the amount of space along a free side of the bench. This can be quite limiting, particularly if the tool is not used often because it reduces the available working space of the bench for use the rest of the time.

Further, the space available for a work bench in a garage or home workshop is often very limited and cramped. This is typically due to the overall shortage of space in a built-up urban environment. That is, very often the work bench in a garage or home workshop is of a small and compact size to enable it to be received within the available space. In these situations, it is even more important to use the available work bench space as efficiently as possible.

Any reference to known art in the background above is not and should not be taken as an acknowledgment or any form of suggestion that the referenced known art forms part of the common general knowledge. In light of the devices disclosed in the known art, it is submitted that the present invention substantially diverges in design elements and methods from the known art and consequently it is clear that there is a need in the art for an improvement for stands for a power tool or appliance. In this regard the instant invention substantially fulfills these needs.

### SUMMARY OF THE INVENTION

In view of the foregoing disadvantages inherent in the known types of stands for a power tool or appliance now present in the known art, the present invention provides a new stand for a power tool or appliance wherein the stand enables a tool or appliance to be positioned on a work surface or work bench for use and also be lifted up off the bench and out of the way when the tool or appliance is not being used.

According to one aspect of the invention there is provided a stand for a device that is a tool or an appliance, the stand comprising: a base for mounting to an external mounting surface; a transitioning arrangement having one end mounted to the base and an opposed end remote from the base; and a mount for mounting a device thereon that is mounted on the opposed end of the transitioning arrangement, wherein the transitioning arrangement enables the mounting formation to be displaced between a raised inoperative configuration for storage, and a lowered operative configuration for use.

The device configured to be mounted on the mount may be a tool that is a power tool for use on a work bench. Alternatively, the device configured to be mounted on the support may be a kitchen appliance of the type that is typically used on a kitchen benchtop or kitchen counter.

In some embodiment, the base comprises a base plate and a fixing arrangement for fixing the base plate to an external structure.

In some applications, the external structure is a horizontally extending member, e.g. work bench or the like, and the fixing arrangement secures the base plate to the horizontally extending member. For example, the horizontally extending member may be a work bench having clearance beneath the actual work bench.

In other applications, the external structure is a vertically extending member, e.g. a wall such as a kitchen wall or a kitchen cupboard wall.

In some embodiments, the fixing arrangement includes fasteners for fastening the base to the external structure. The fasteners may be screws or bolts that are driven into the external structure to fix the base to the structure.

In alternate embodiments, the fixing arrangement includes a clamp for clamping the base to an external structure. This fixing arrangement may be particularly convenient where the external structure is a horizontally extending member and there is some clearance beneath the member.

In some embodiments, the mount includes pivot pins that pass through the mount and the transitioning arrangement for permitting the mount to pivot relative to the transitioning arrangement, e.g. when moving between the raised and lowered positions.

In some embodiments, the transitioning arrangement comprises a mechanical arrangement configured to transition between the raised stowed configuration and the lowered operative configuration.

In some embodiments, the transitioning arrangement comprises one transitioning member, whereas in other embodiments, the transitioning arrangement comprises a plurality of transitioning members extending between the base and the mount.

In some embodiments, the transitioning arrangement comprises a plurality of mechanical members configured to pivot relative to the base and the mount to transition between the raised inoperative and lowered operative configurations.

In some embodiments, the transitioning arrangement comprises a plurality of transitioning members forming a parallelogram linkage.

In some embodiments, the stand includes pins passing through the base and the transitioning arrangement for permitting the mount to pivot relative to the transitioning arrangement when moving between the raised and lowered positions.

In some embodiments, the stand also includes pins passing through the mount and the transitioning arrangement for permitting the mount to pivot relative to the transitioning arrangement when moving between the raised and lowered positions.

In other embodiments, the transitioning arrangement further includes a compression strut for damping movement of the arrangement between the raised stowed and lowered inoperative configurations and assisting a user to interchange the stand between the raised and lowered configurations.

In alternate embodiments, the transitioning mechanism comprises a torsion spring, or an extension spring. Further, in some embodiments, the transitioning mechanism also comprises an actuator, e.g. a linear actuator.

In some embodiments, the mount comprises a mounting plate suitable for mounting a device thereon in a configuration in which the device can be used.

The device may be a power tool and some examples of power tools that may be mounted on the mounting formation include: Drill, including drill press, bench or angle grinder, metal cut off saw, miter saw, band saw, scroll saw, fret saw, disc sander, hot wire cutter, hole punch, press, or die.

Alternatively, the device may be a kitchen appliance mounted on the mounting plate and some examples of kitchen appliances include a toaster, air fryer, kettle, mixer and toasted sandwich maker.

In some embodiments, the mount is movably mounted on the transitioning member so that it can move in a single plane in a direction transverse to the pivoting when moving between the raised and lowered positions.

In other embodiments, the mount is movably mounted on the transitioning member so that it can be pivoted left and right in a substantially horizontal plane. This enables the mount, and a tool mounted on the mount, to be moved sideways out of the way during workshop operations, and then also be moved back into its first position when required. This is separate and distinct from moving the mount between the raised and lowered positions.

In some embodiments, the mount is configured to be manually moved by a user left and right in a substantially horizontal plane to move a tool or appliance out of the way.

According to another aspect of the invention there is provided a power tool mounted on a stand wherein the stand is in accordance with a preceding aspect of the invention.

According to another aspect of the invention there is provided an appliance mounted on a stand wherein the stand is in accordance with a preceding aspect of the invention.

Further, in some embodiments, the stand includes any one or more of the features of the stand defined in a preceding aspect of the invention.

It is therefore an object of the present invention to provide a new and improved stand for a power tool or appliance that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings. A stand for a power tool or for an appliance in accordance with the invention may be achieved in a variety of forms. It will be convenient to hereinafter describe in detail several embodiments of the invention with reference to accompanying drawings. The purpose of providing this detailed description is to instruct persons having an interest in the subject matter of the invention how to carry the invention into practical effect. However, it is to be clearly understood that the specific nature of this detailed description does not supersede the generality of the preceding summary section. In the drawings:

FIG. 1 is a perspective view a work bench illustrating placement of a tool permanently mounted in a single position on the surface of the work bench.

FIG. 2A is a side view of an embodiment of the stand in a raised stowed configuration.

FIG. 2B is a front view of an embodiment of the stand in a raised stowed configuration.

FIG. 2C is a top plan view of a first end of an embodiment of the stand.

FIG. 2D is a top plan view of a second end of an embodiment of the stand.

FIG. 2E is a top planar view of an embodiment of the stand in a lowered operative configuration.

FIG. 3 is a perspective view of an embodiment of the stand in a raised stowed configuration.

FIG. 4 is a perspective view of an embodiment of the stand in a lowered operative configuration on the work bench.

FIG. 5 is a perspective view of an embodiment of the stand in a raised stowed configuration positioned above a work bench, wherein a tool is mounted on the stand.

FIG. 6A is a top plan view of an alternate embodiment of the stand.

FIG. 6B is a top plan view of an alternate embodiment of the stand, wherein the platform is rotated relative to the support.

FIG. 7A is a top plan view of an embodiment of the stand having three stands simultaneously mounted to a work bench.

FIG. 7B is a top plan view of an embodiment of the stand having three stands simultaneously mounted to a work bench, wherein a first stand is in a lowered operative configuration.

FIG. 8A is a perspective view of an embodiment of the stand in a raised inoperative position.

FIG. 8B is a perspective view of an embodiment of the stand, wherein the stand is lowered into an operative position in a work zone.

FIG. 8C is a perspective view of an embodiment of the stand, wherein the stand is pivoted to line up with an edge of the work bench.

FIG. 9 is a perspective view of an embodiment of the stand having a tool mounted thereon, wherein the stand is in a raised inoperative configuration.

FIG. 10 is a perspective view of an embodiment of the stand of FIG. 9 in a lowered operative configuration.

FIG. 11 is a close-up view showing additional detail of the transition arrangement for the stand of FIG. 10.

FIG. 12A is a side view of an embodiment of the stand in a first configuration.

FIG. 12B is a side view of an embodiment of the stand in a second configuration.

### DETAILED DESCRIPTION OF THE INVENTION

Reference is made herein to the attached drawings. For the purposes of presenting a brief and clear description of the present invention, the preferred embodiment will be discussed as used for supporting a tool on a stand, in both an operative and stowed position, while the stand is secured to a support surface. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. Additionally, the term “comprising” is intended to denote the inclusion of a stated integer or integers, but not necessarily the exclusion of any other integer, depending on the context in which that the term is used. This applies to variants of that term such as “comprising” or “comprises”. Further in this specification, the term “stand” shall be understood to refer to a device for supporting a tool or appliance on a work bench or counter that is used for displacing the tool or appliance from a stowed position for storage down to the work bench or counter for use by a user. Additionally, “tool” refers to any implement or item that is used for a set purpose, including, but not limited to a power tool or appliance.

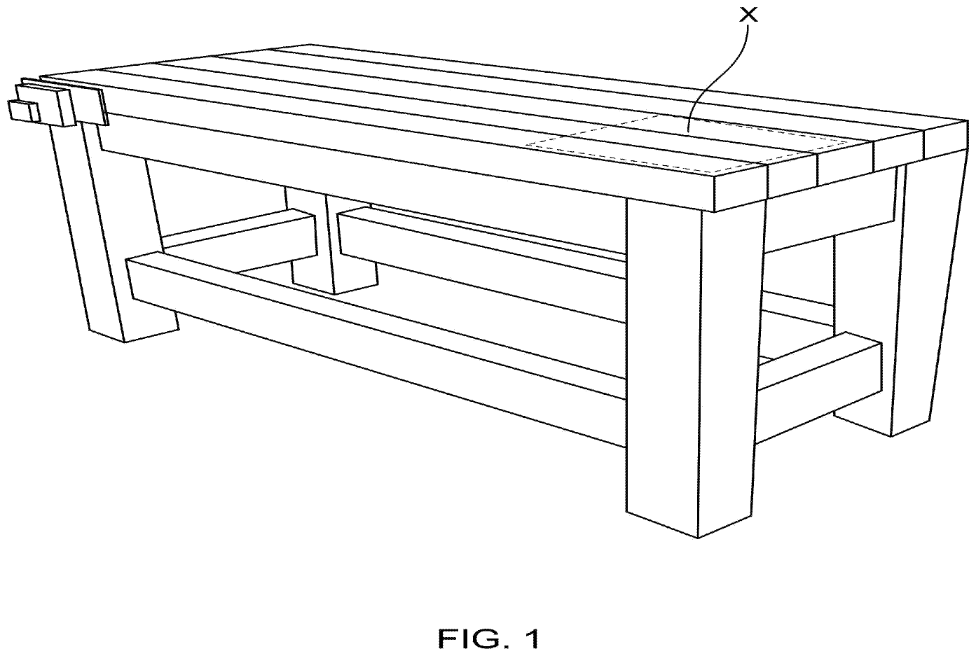

FIG. 1 illustrates a traditional work bench having a power tool permanently mounted thereto in a position along a side of the tool. As this is known in the known art, and it does not form part of the invention, it will not be described in further detail in this detailed description.

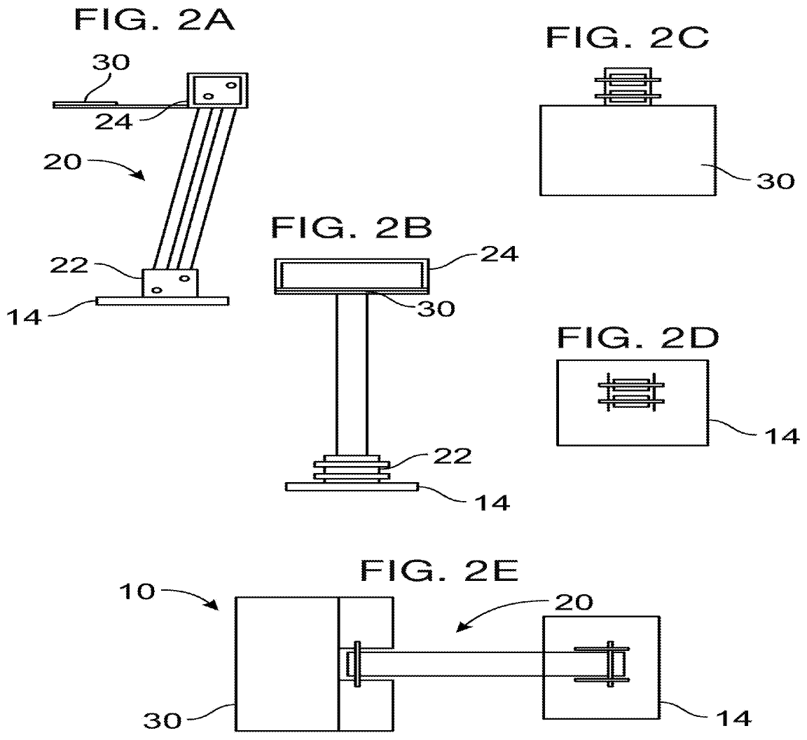

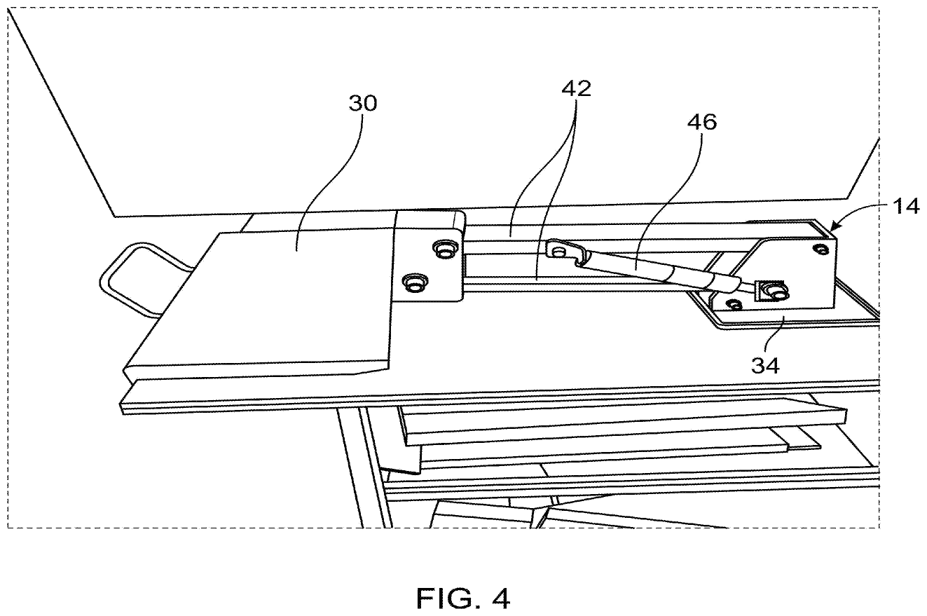

FIGS. 2A to 4 illustrate a stand for a power tool in accordance with one embodiment of the invention. In the drawings, the stand will be referred to generally by the reference numeral 10.

The stand 10 for a power tool comprises a base 14 for mounting to an external mounting structure 16, a transitioning arrangement 20 having one end 22 mounted to the base 14 and an opposed end 24 remote from the base 14. It also includes a mount 30 for mounting a device that is a tool thereon that is mounted on the opposed or upper end of the transitioning arrangement 20. The transitioning arrangement 20 is manually operable by a user to move the mount 30 between a raised inoperative configuration (second configuration) for storage of the tool 32 and a lowered inoperative configuration (first configuration) suitable for use of the tool.

The base 14 comprises a base plate 33 and a fixing arrangement 34 for fixing the base plate 33 to the external structure 16.

In the illustrated embodiment, the external structure 16 is a horizontally extending member that is a work bench having a member 18 with some space and clearance beneath it.

The fixing arrangement 34 comprises a fastening arrangement having a plurality of fasteners 36 that are passed through the base plate 33 and the external structure 16 to securely mount the base 14 on the structure 16.

In another embodiment that has not been illustrated, the fixing arrangement 34 comprises a clamp that clamps the base plate 33 to the member 18 of the work bench. As clamps of this general nature would be known in the art and do not form part of the invention, they will not be described in greater detail in this specific description.

The mount 30 comprise a mounting plate 40 on which the power tool is mounted. Some examples of power tools that may be mounted on the mounting formation include drills, angle grinders, hole punches, dies, and presses.

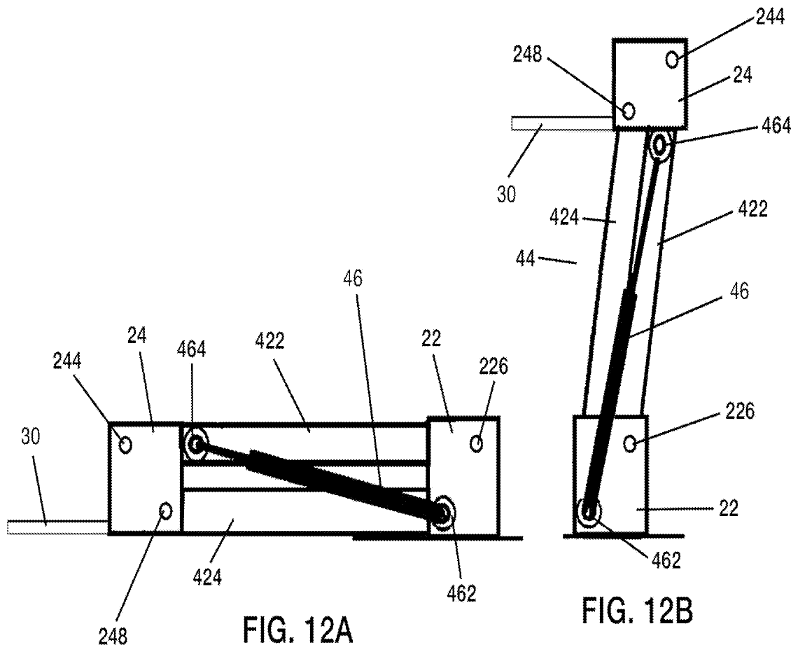

In FIGS. 2A to 4, the transitioning arrangement 20 comprises a plurality of transitioning members 42 forming an assembly or linkage 44 that is moveable or interchangeable between the raised stowed and inoperative configuration (as seen in FIG. 12B) and the lowered operative configuration (as seen in FIG. 12A). In particular, the transitioning arrangement 20 is in the form of four transitioning members 42 connected to form a mechanical linkage, e.g. a parallelogram linkage 44, that can be moved between the raised and lowered configurations. However, it will be appreciated that other mechanisms and, in particular other mechanical linkages can also be used.

The transitioning arrangement 20 further includes a compression strut 46 extending between the base plate 32 and the transitioning members 42. The compression strut 46 damps movement of the transitioning arrangement 20 between the raised stowed and lowered inoperative configurations. That is, it damps movement of the mount 30 (and the tool or appliance mounted thereon) when it is lowered into the operative configuration from the stowed raised configuration. It also assists a user to lift or raise the mount 30 and associated tool back up to the raised stowed configuration after it has been used. When lowering the mount 30, the strut 46 slows the descent of the mount 30 particularly when it gets towards its end of range. This is similar in some respects to a compression strut used to support a hatch back of a motor vehicle. The pressure of fluid in the strut 46 also reduces the lifting effort required to lift the mount 30 (and associated tool) up again.

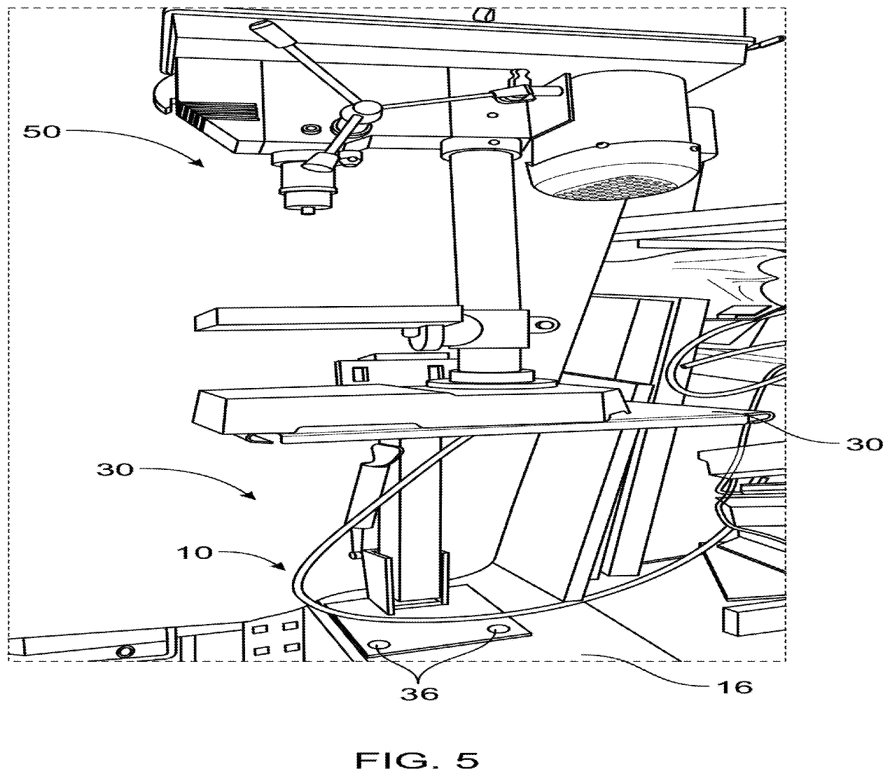

FIG. 5 illustrates a tool that is a high-speed drill that is mounted on the tool support shown in FIGS. 2A to 5. In the drawing, the tool is indicated generally by the reference numeral 50. The tool illustrated in FIG. 5 is a drill but there are many power tools that might be used in this situation including a drill or an angle grinder.

The stand 10 and tool 50 mounted thereon is shown in the raised stowed position in FIG. 5. The base 14 is mounted on the work bench 16 but the mount 30 and accompanying tool 50 may be spaced a distance of 400 to 600 mm, for example, above the surface of the work bench 16. This then enables the space on the surface of the work bench (that would otherwise be occupied by the tool 50), to be utilized for other activities.

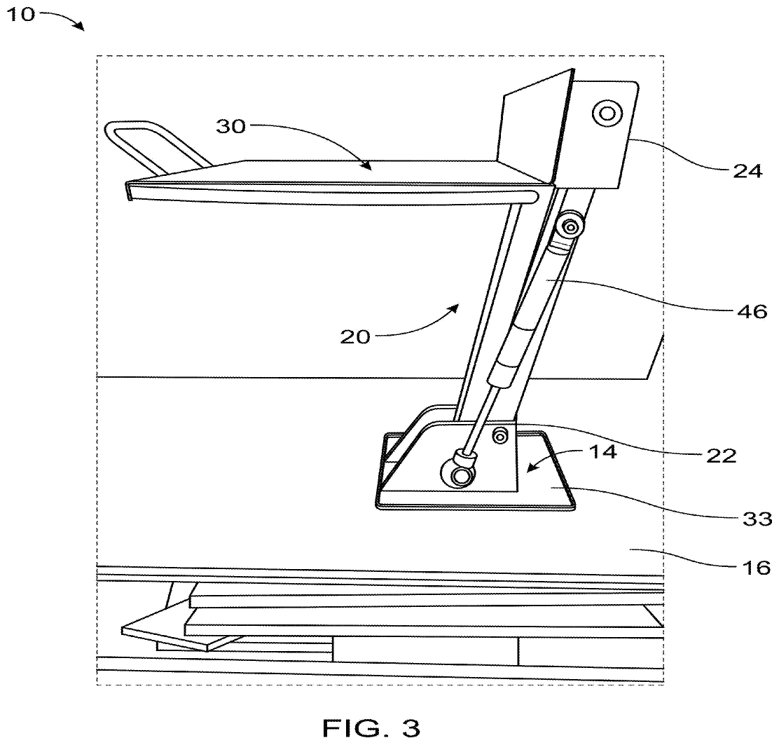

In use, the stand 10 has the power tool 50 mounted thereon that is used, some of the time when the work bench 16 is used, but not all the time. In between discrete uses of the tool 50, the mount 30 is positioned in the raised inoperative configuration shown in FIGS. 3 and 5. In this position, it is spaced above the work bench 16 and does not occupy any space on the work bench 16. Further, it does not interfere with the use of the work bench 16 over the area that it occupies when in the operative configuration. This leaves this space available for use in other activities that may be carried out by the user.

When the tool 50 is required for use, the user operates the transitioning arrangement 20 to move the mount 30 and tool 50 mounted thereon to the lowered operative configuration where the mount 30 is resting on the work bench 16. This is accomplished by a manual process in which the user maneuvers the parallelogram linkage 44 to lower the mount 30. This action is assisted by the compression strut 46 that damps the descent of the mount 30, and it also vertically supports the mount 30 and the tool 50 positioned thereon.

The tool 50 can then be used in the usual way on the work bench 18. When its use has been completed, the user simply lifts the mount 30 and accompanying tool 50 back up into the stowed inoperative configuration. In a more typical application of the invention, the tool 50 is permanently mounted on the mount 30 of the stand 10.

In another variation of this use, the tool 50 can be stored separate from the stand 10 and only mounted on the stand 10 when it is lowered into its operative position for use. The tool 50 is then fixed to the stand 10 at the time of use and then used in the normal way. When use of the tool 50 is completed, the tool 50 is removed from the mount 30 by removing the fasteners 36 and lifting the tool 50 off the mount 30. The stand 20 is then moved back up to the raised inoperative position.

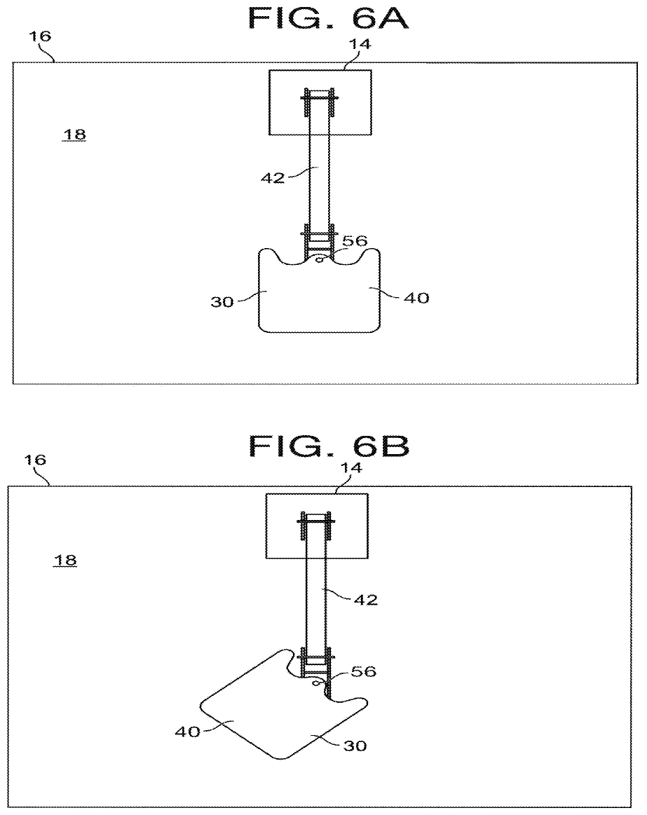

FIGS. 6A and 6B schematically illustrates a stand 10 for a power tool or an appliance in accordance with another embodiment of the invention. The stand 10 in FIGS. 6A and 6B have some similarities to the stand 10 described above with reference to FIGS. 2A to 4 and therefore the same reference numerals will be used to refer to the same components. However, it has an additional feature that will be described below.

In the stand of FIGS. 6A and 6B, the mount 30 is pivotally mounted on the upper end of the transitioning arrangement 20 in a way that permits the mounting plate 40 to pivot from left to right on the linkage 44. That is, it can pivot left and right at the same height while it is in either the raised or the lowered positions. This is something quite different to the pivoting that occurs when the linkage 44 moves the stand 10 between the raised inoperative and lowered operative positions. Typically, this might be done to move the mount 30 and tool 50 thereon temporarily to one side while another work activity is carried out.

This arrangement comprises a pivot pin 56 that is passed through the mounting plate 40 and also the upper end of the linkage 44. The arrangement may also include one or more washers that enable the mounting plate 44 to pivot freely on the linkage. This enables the mounting plate 40 and tool mounted thereon to be pivoted from one side to another with minimal effort.

The feature that allows the mount 30 and the tool 50 mounted thereon to be pivoted in a single horizontal plane during use of a tool or appliance on the work bench, enables a user or operator to pivot the mount 30 quickly and easily to a different position (at the same height) while they are working, and this confers additional versatility on the stand 10 for the tool 50.

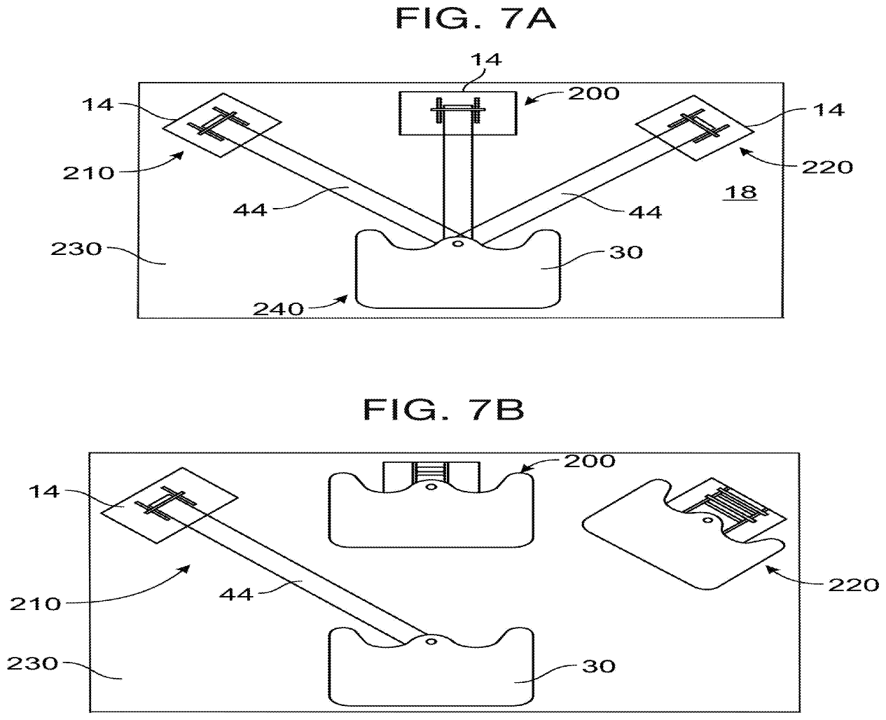

FIGS. 7A and 7B illustrate a work bench having three stands for tools arranged thereon.

One of the stands 200 is centrally mounted and the other two stands 210 and 220 are arranged symmetrically on either side of the central stand 200. As shown in the drawings, each stand 210 and 220 is arranged at about forty-five degrees to the central stand 200, and also with an edge of the work bench 230. Further, each of the stands has a power tool, e.g. typically a different power tool, mounted thereon. The arrangement in FIGS. 7A and 7B enable each of the three stands 200, 210 and 220 to interchangeably occupy a single work zone indicated by reference numeral 240 on the work bench 230. This arrangement enables a more efficient utilization of a unit surface area of work bench 230.

Each of the three stands 200, 210 and 220 is stowed in the raised inoperative configuration in which the support or mount 30 on the stand is spaced above the work bench 230. This enables the work zone 240 to be used for other activities e.g. using basic hand tools to work on a work piece resting on the work bench 230.

When a user desires to use a tool mounted on one of the stands 200, 210 or 220, they lower the stand (and particularly the mount 30 thereof) into the lowered operative position with the support or mount 30 mounted on the work bench 240. The other two stands 210 and 220 remain in the raised inoperative position.

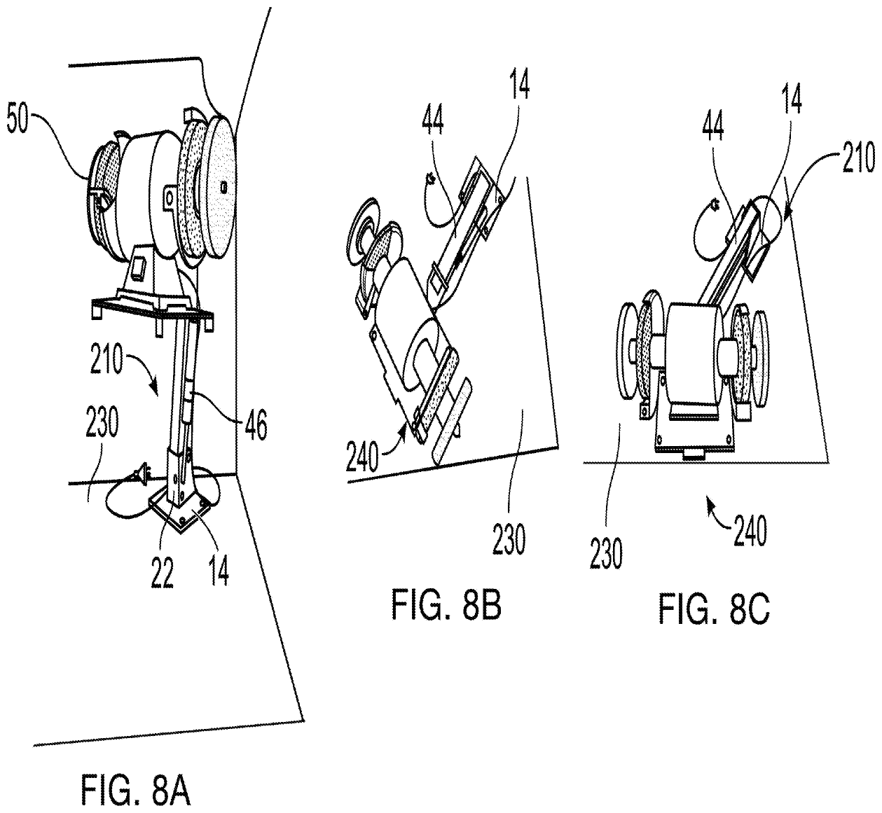

If the stand 200 is lowered into the operative position, then no pivoting of the mount 30 on the transition arrangement 20 in the form of a linkage is required. However, if one of the other stands 210 or 220 needs to be used, and the stand 210 or 220 is lowered into its operative position, then the mount would typically not be square with an edge of the work bench 230. It would be at angle of 45 degrees (being the angle at which the mount 30 is mounted on the work bench 230). In this case, the mount 30 can be pivoted through 45 degrees to bring it square with the edge of the work bench 230 in the orientation that is most suitable and comfortable for use. This process of lowering the stand 210 (mounted at an angle of 45 degrees) and then pivoting the mount 30 into position is shown in FIGS. 8A to 8C of the drawings.

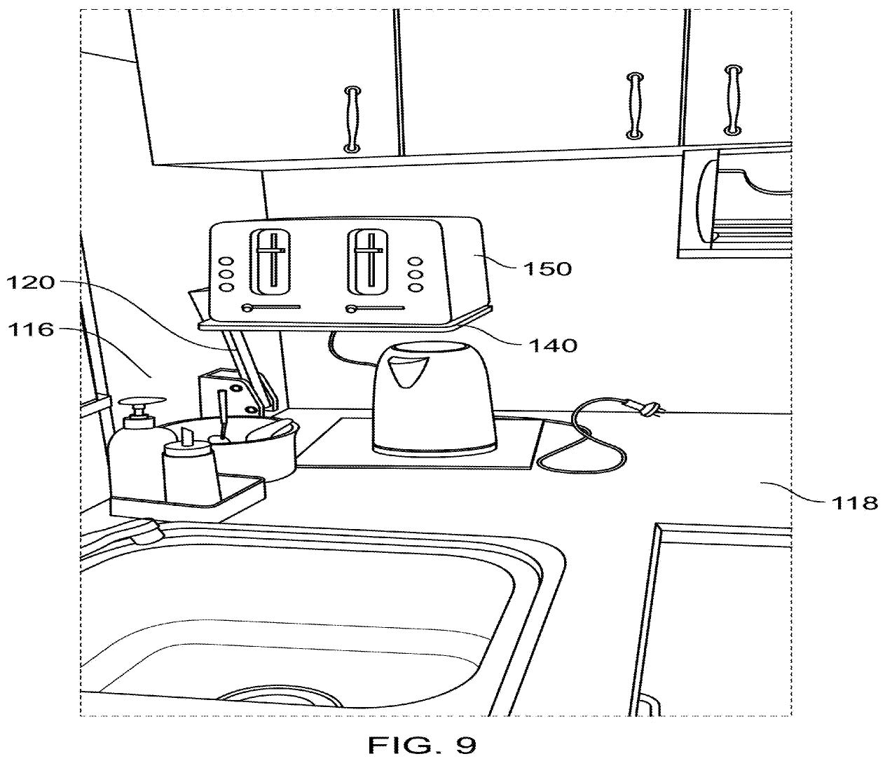

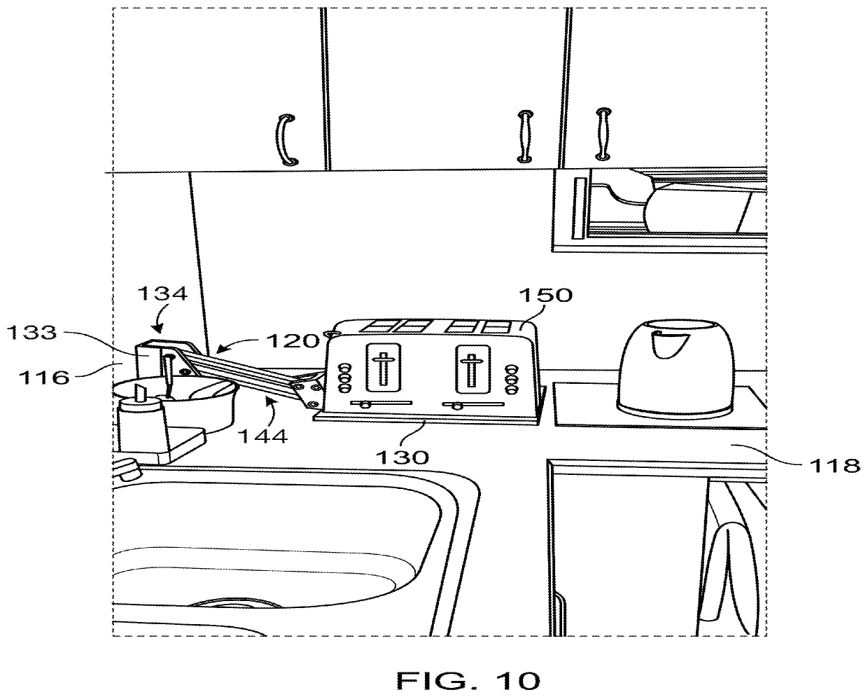

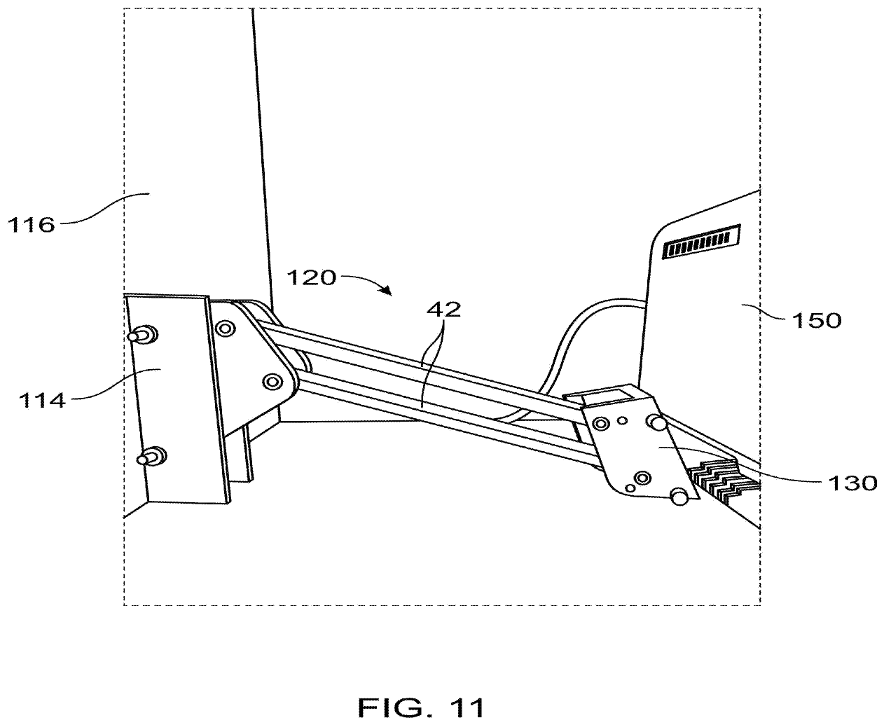

FIGS. 9 to 11 illustrate a stand in accordance with yet another embodiment of the invention. The stand in FIG. 9 is similar to the stand described above with reference to FIGS. 2A to 4 and therefore the same reference numerals will be used to refer to the same components unless otherwise indicated. The key difference is that the stand in FIGS. 9 to 11 is for use in a kitchen to hold a kitchen appliance and enable it to be moved between a raised inoperative position and a lowered operative position in which the appliance is on the kitchen counter.

The stand 100 in FIGS. 9 to 11 carries or supports a kitchen appliance 150. The stand 10 enables the appliance 150 to be stowed out of the way spaced above a kitchen counter 118 and then be lowered onto the kitchen counter 118 for use when required. This thereby frees up the space that the appliance occupied on the counter 118 for use in other activities. Some examples of kitchen appliances 150 that may be mounted on the stand 100 include: toasters, air fryers, kettles, mixers, and toasted sandwich machines. However, there are also many other appliances that could also be used on the stand 100 that have not been named in this list.

In FIGS. 9 to 11, the fixing arrangement 134 clamps the base plate 133 to an external structure that is a vertically extending member 116, e.g. a vertically extending surface in a kitchen formed by a wall or cupboard. Typically, this is accomplished by fastening the base plate 33 to a wall 116 using a plurality of fasteners (not shown) that are passed through the base plate 133 and into the wall or cupboard 116.

The transitioning arrangement 120 in the embodiment in FIGS. 9 to 11 is very similar to that shown in FIGS. 2 to 5. That is, it comprises a parallelogram linkage 144 extending between the base plate 133 and the mount 130.

In use, the stand in FIGS. 9 to 11 is used to carry or support an appliance that is a toaster 150 like that shown in the drawings. The stand 10 enables the toaster 150 to be stowed in a raised inoperative position above the kitchen counter 118 when it is not in use. As shown in the drawings, the toaster 150 might typically be 50-80 cm above the kitchen counter 116 in the raised position. This enables other appliances and devices such as a kitchen kettle or a chopping board to be placed on the counter directly beneath the toaster and be used in the normal way when the toaster is in the raised inoperative position.

When the toaster 150 is required for use in making toast (e.g. at meal times) the space on the counter 116 which it occupies when in the lowered operative position is cleared, and the toaster 150 is then moved down into its operative position. This is done manually by lowering the mount 30 (on which the toaster 150 is sitting) down onto the kitchen counter 116.

The toaster 150 can then be plugged into a power supply and used in the normal way to make toast. Then when its use is completed, the toaster 150 can once again be raised up to the raised inoperative position, thereby once again making the space on the counter available for other uses.

A working advantage of the stand described above with reference to FIGS. 2A to 5 is that it provides a work bench that is free of fixed power tools. The stand helps to free up workspace on the work bench so that the full work bench surface can be utilized for working activities. This is particularly advantageous where a compact work bench is being used because of limited available space.

The invention is particularly useful for tools and appliances that are used infrequently because it enables them to be stored out of the way where they do not occupy valuable counter space on a work bench or a kitchen counter.

The stand enables a power tool, for example, to be quickly and easily raised up to its inoperative position spaced above the work bench where it frees up the work bench for other activities. While the stand is manually moved by the user from the lowered operative position to the stowed upper position, this can be quickly and easily accomplished without substantial effort on the part of the user. This is due to the gas strut or compression strut mounted on the transitioning arrangement that helps to lift the stand and tool. Similarly, the mount and the power tool mounted thereon can be quickly and easily lowered from the raised upper position to the operative lower position when the tool is required for use. The strut helps to arrest the descent of the stand and tool.

Similarly, the stand described above and illustrated in FIGS. 9 to 11 is useful for storing away a kitchen appliance between uses. This frees up the available bench space (which is often limited in a kitchen) for use in other activities.

Yet another advantage of the stand illustrated in the drawings is that it can be manufactured and provided to the public at a reasonable cost. The structure is not complicated and is extremely strong and reliable in use.

In summary the stand provides a vehicle or even an apparatus that is able to conveniently 20 displace or transport the power tool or appliance backwards and forwards between its storage position and also its working or operative position on the work bench.

Referring now to FIGS. 12A and 12B, there are shown side views of an embodiment of the stand in a first configuration and a second configuration, respectively. The stand comprises the transitioning arrangement having at least one mechanical linkage 44. In the illustrated embodiment, the mechanical linkage 44 comprises a front rail 424 and a rear rail 422, wherein the front rail 424 and the rear rail 422 have a first end 22 extending from the base at respective pivot points 462, 226, and a second end 24 extending from the mount 30 at respective pivot points 248, 244. The mount 30 comprises a platform configured to receive the tool thereon.

In some embodiments, the mount further comprising a back plate that extends perpendicularly from an edge of the platform and configured to prevent the tool from moving beyond a rear side of the mount. In some embodiments, the platform comprises a first end secured to the second end of the transitioning arrangement and a second end having a lip, wherein the lip is configured to overhang an edge of the support surface in the first configuration. In other embodiments, a handle extends from a perimeter of the platform, wherein the handle is entirely disposed above a lower side of the platform to prevent forming an obstruction with the support surface.

The transitioning arrangement is pivotally secured to the base and adapted to transition the mount 30 between a first configuration and a second configuration. In the illustrated embodiment, in the first configuration, the mount 30 is rotated horizontally away from the base in an operative position, wherein the operative position the tool is configured for normal operation and usage by a user. In the illustrated embodiment, in the second configuration, the mount 30 is rotated vertically towards the base and adapted to move the mount 30 to a stowed position, wherein the stowed position means that the tool, and the platform on which it rests, is elevated, or lowered from a support surface such as a countertop or workbench surface. The platform is pivotally connected to the front and rear rails 424, 422 via the pivot points 248, 244 such that the platform is configured to remain aligned on a horizontal plane in the first configuration and the second configuration to keep the tool in an upright position. In the illustrated embodiments, the pivot points each comprise a pin extending from a first lateral side to an opposing second lateral side of either the mount or the base.

In the shown embodiment, the stand comprises a multi-positional pneumatic arm 46 connected to at least one of the rails and configured to retain the configuration of the mount in the first configuration, the second configuration, and while transitioning therebetween. As a result, the orientation of the mount 30 is independent of movement of the transitioning arrangement between the first configuration and the second configuration. The pneumatic arm is disposed between the base and the transitioning arrangement and configured to slow a descending movement of the mount when transitioning to the first configuration and reduce external force needed to lift the mount when transitioning to the second configuration. In some embodiments, the multi-positional pneumatic arm 46 is a gas compression strut.

The pneumatic arm comprises a first end pivotally connected to the base at a first point 462 and a second end pivotally connected to the rear rail at a second point 464. The front rail 424 is also pivotally connected to the base at the first point 462. However, in alternate embodiments, the first end of the arm 46 is connected to any suitable position on the base, such as an alternate point below the first point 462. The first point 226 is offset from the second point 462 along both a horizontal plane and a vertical plane of the second point.

In some embodiments, as seen in FIG. 12B, a sidewall of the front rail 424 contacts an adjacent sidewall of the rear rail 422 in the second configuration. The sidewall of the front rail and the adjacent sidewall of the rear rail are disposed along a length of the front rail and the rear rail, respectively. In the first configuration, the sidewall of the front rail 424 and the adjacent sidewall of the rear rail 422 are separated, forming a space therebetween, as seen in FIG. 12A.

In the illustrated embodiment, the mount comprises a pair of plate members that house the second end of the transitioning arrangement. The pair of plate members of the mount are substantially parallel to each other and perpendicular to the platform. The base also comprises a pair of plate members that house the first end of the transitioning arrangement, wherein an orientation of the base remains unchanged between the first configuration and the second configuration.

In the second configuration, the pair of plate members of the mount is offset from the base, along a central longitudinal axis of the stand and towards a rear side thereof. This offset configuration allows the stand to increase is structural strength. In the second configuration, the arm 46 is fully extended and not under a load. The arm 46 is configured to be under a load with the mount is moved forward. In the illustrated embodiment, the first end and the second end of the transitioning arrangement are disposed on the same horizontal plane in the first configuration.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A stand for a tool, comprising:
a transitioning arrangement having at least one mechanical linkage, wherein the transitioning arrangement includes a first end and an opposing second end;
a base extending from the first end of the transitioning arrangement, wherein the base is configured to secure to a support surface;
a mount disposed on the second end of the transitioning arrangement, wherein the mount comprises a platform adapted to support the tool thereon;
wherein the transitioning arrangement is pivotally secured to the base and adapted to transition the mount between a first configuration and a second configuration;
wherein the first configuration, the mount is rotated horizontally away from the base in an operative position;
wherein the second configuration, the mount is rotated vertically towards the base and adapted to move the mount to a stowed position;
wherein the platform is pivotally connected to the transitioning arrangement such that the platform is configured to remain aligned on a horizontal plane in the first configuration and the second configuration to keep the tool in an upright position.

2) The stand of claim 1, wherein the at least one mechanical linkage comprises a front rail and a rear rail, wherein the front rail and the rear rail each extend from the base to the mount.

3) The stand of claim 1, wherein an orientation of the mount is independent of movement of the transitioning arrangement between the first configuration and the second configuration.

4) The stand of claim 2, wherein the rear rail is pivotally connected to the base at a first point and the front rail is pivotally connected to the base at a second point, wherein the first point is offset from the second point along both a horizontal plane and a vertical plane thereof.

5) The stand of claim 2, wherein a sidewall of the front rail contacts an adjacent sidewall of the rear rail in the second configuration, wherein the sidewall and the adjacent sidewall are disposed along a length of the front rail and the rear rail, respectively.

6) The stand of claim 5, wherein the sidewall and the adjacent sidewall are separated, forming a space therebetween, in the first configuration.

7) The stand of claim 1, further comprising a multi-positional pneumatic arm configured to retain the configuration of the mount in the first configuration, the second configuration, and while transitioning therebetween, wherein the pneumatic arm is adapted to assist with the transition between the first and second configuration.

8) The stand of claim 6, wherein the pneumatic arm comprises a first end pivotally connected to the base and a second end pivotally connected to the rear rail.

9) The stand of claim 6, wherein the pneumatic arm is disposed between the base and the transitioning arrangement, configured to slow a descending movement of the mount when transitioning to the first configuration and reduce external force needed to lift the mount when transitioning to the second configuration.

10) The stand of claim 1, wherein the mount further comprises a pair of plate members that house the second end of the transitioning arrangement and the base houses the first end of the transitioning arrangement, wherein an orientation the base remains unchanged between the first configuration and the second configuration.

11) The stand of claim 10, wherein the pair of plate members of the mount is offset from the base, along a central longitudinal axis of the stand and towards a rear side thereof, in the second configuration.

12) The stand of claim 1, wherein the mount is configured to rotate about a longitudinal axis while disposed on the horizontal plane.

13) The stand of claim 1, further comprising a fixing arrangement configured to secure the base to the support surface, wherein the fixing arrangement comprises a fastener.

14) The stand of claim 1, further comprising a back plate that extends perpendicularly from an edge of the platform and configured to prevent the tool from moving beyond a rear side of the mount.

15) The stand of claim 1, wherein the platform comprises a first end secured to the second end of the transitioning arrangement and a second end having a lip, wherein the lip is configured to overhang an edge of the support surface in the first configuration.

16) The stand of claim 1, further comprising a handle extending from a perimeter of the platform, wherein the handle is entirely disposed above a lower side of the platform to prevent forming an obstruction with the support surface.

17) The stand of claim 1, wherein the first end and the second end of the transitioning arrangement are disposed on the same horizontal plane in the first configuration.

18) The stand of claim 1, wherein the transitioning arrangement is moved manually, wherein no external power source is used to raise and lower the mount.

19) The stand of claim 1, wherein the platform of the mount rests flush against the support surface when in the first configuration.

20) The stand of claim 1, further comprising a plurality of stands each having a base simultaneously secured to the support surface, wherein the platform of each of the plurality of stands are configured to occupy a same space when in the first configuration.
